(19) United States
(12) Patent Application Publication
(10) Pub. No.: US 2019/0007293 A1
(43) Pub. Date: Jan. 3, 2019

(54) APPARATUS AND METHOD FOR CORRELATING NETWORK TRAFFIC ON OPPOSITE SIDES OF A NETWORK ADDRESS TRANSLATOR

(71) Applicant: Cpacket Networks Inc., San Jose, CA (US)

(72) Inventor: Ron Nevo, Portland, OR (US)

(73) Assignee: Cpacket Networks Inc., San Jose, CA (US)

(21) Appl. No.: 15/636,551

(22) Filed: Jun. 28, 2017

(51) Int. Cl. H04L 12/26; H04L 12/743; H04L 29/12; H04L 29/06

(52) U.S. Cl. CPC H04L 43/0876; H04L 43/04; H04L 43/106; H04L 61/2517; H04L 69/16; H04L 45/7453

(57) ABSTRACT

A machine has a processor and a memory connected to the processor. The memory stores instructions executed by the processor to evaluate internal packets from a first side of a network address translator with a first internet protocol address and a first port designation. External packets from a second side of a network address translator with a second internet protocol address and a second port designation are evaluated. A session start packet match is identified within the internal packets and the external packets. A session entry with a session start time is created in response to the session start packet match. A session end match is identified within the internal packets and the external packets. A session end time is recorded in response to the session end match.

### FIELD OF THE INVENTION

This invention relates generally to communications in computer networks. More particularly, this invention is directed to correlating network traffic flows on opposite sides of a network address translator.

### BACKGROUND OF THE INVENTION

FIG. 1 illustrates a prior art system 100. A set of private client devices 102A through 102N use a common Internet Protocol (IP) address (e.g., IP address X 104) to access network address translator 106. The network address translator 106 is a network traffic routing device. The client device may be any client device capable of wired or wireless IP communications.

The network address translator 106 remaps the IP address into another IP address by modifying network address information in IP datagram packet headers. The network address translator 106 also changes port designations (e.g., Transmission Control Protocol (TCP) or User Datagram Protocol (UDP) port designations). FIG. 1 illustrates Packet A 104 originates from a private client device 102A with an IP Address X and a port designation of Z before the network address translator 106. After the network address translator 106 Packet A 108 has an IP address of Y and a port designation of B, which is applied to network 110 for further processing.

The network address translator 106 maintains a mapping of IP addresses between its ingress and egress ports. However, monitoring traffic flows on either side of the network address translator 106 is challenging since different IP addresses and port designations are used on opposite sides of the network address translator 106.

Accordingly, there is a need for correlating network traffic flows on opposite sides of a network address translator.

### SUMMARY OF THE INVENTION

A machine has a processor and a memory connected to the processor. The memory stores instructions executed by the processor to evaluate internal packets from a first side of a network address translator with a first internet protocol address and a first port designation. External packets from a second side of a network address translator with a second internet protocol address and a second port designation are evaluated. A session start packet match is identified within the internal packets and the external packets. A session entry with a session start time is created in response to the session start packet match. A session end match is identified within the internal packets and the external packets. A session end time is recorded in response to the session end match.

A machine has a processor and a memory connected to the processor. The memory stores instructions executed by the processor to classify packets as transmission control protocol signaling packets or transmission control protocol non-signaling packets. Further processing of the transmission control protocol non-signaling packets is omitted. Trailers are appended to the transmission control protocol signaling packets. The transmission control protocol signaling packets and the trailers are forwarded to a network connected device for further evaluation.

### BRIEF DESCRIPTION OF THE FIGURES

The invention is more fully appreciated in connection with the following detailed description taken in conjunction with the accompanying drawings, in which:

FIG. 1 is illustrates a prior art system with a network address translator.

FIG. 2 illustrates a system configured in accordance with an embodiment of the invention.

FIG. 3 illustrates network monitoring device processing performed in accordance with an embodiment of the invention.

FIG. 4 illustrates a trailer formed in accordance with an embodiment of the invention.

FIG. 5 illustrates a forensic network device utilized in accordance with an embodiment of the invention.

FIG. 6 illustrates forensic network device processing performed in accordance with an embodiment of the invention.

FIG. 7 illustrates a management platform utilized in accordance with an embodiment of the invention.

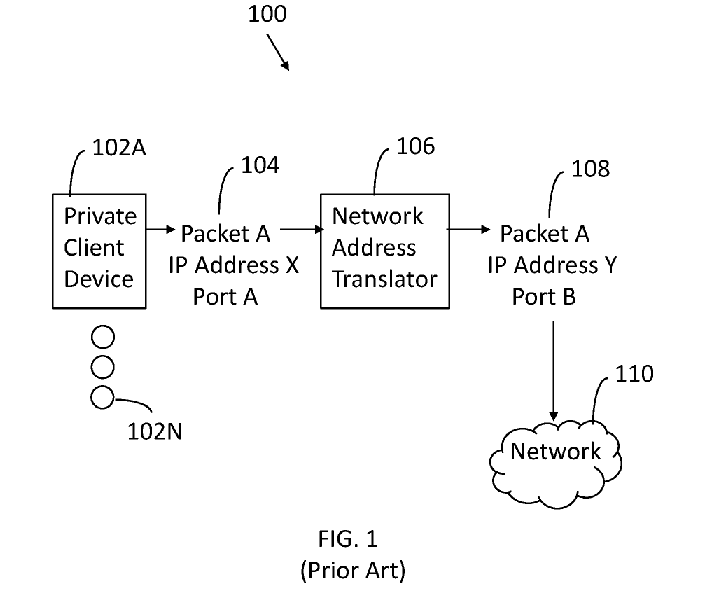

Like reference numerals refer to corresponding parts throughout the several views of the drawings.

### DETAILED DESCRIPTION OF THE INVENTION

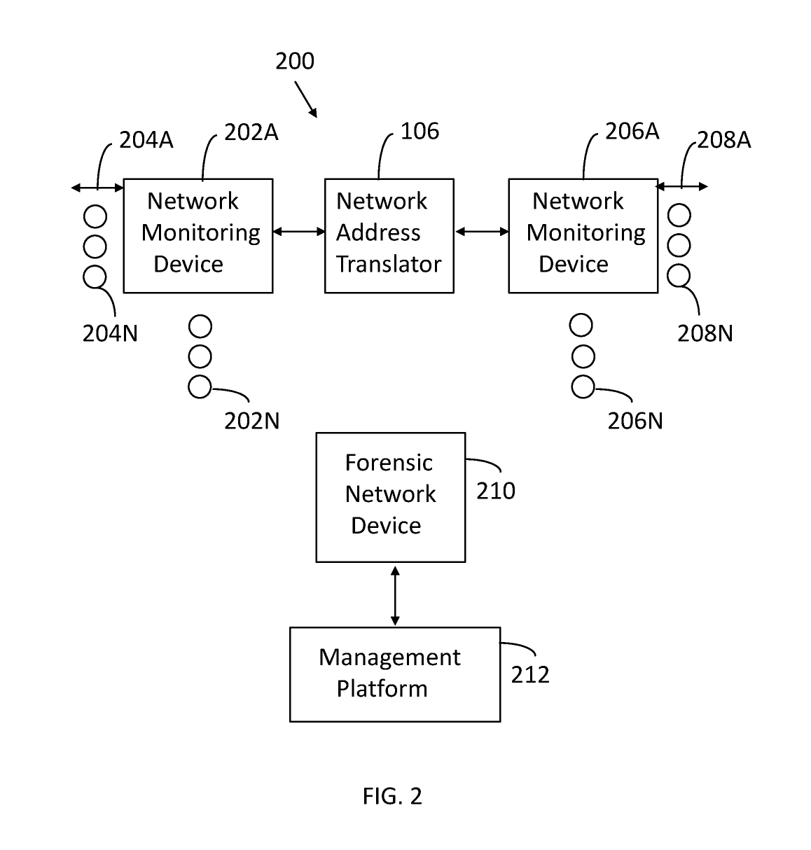

FIG. 2 illustrates a system 200 for network monitoring and network analysis, in accordance with an embodiment of the invention. The system 200 includes network monitoring devices 202A-202N on the ingress side of a network address translator 106 and network monitoring devices 206A-206N on the egress side of the network address translator 106. The network traffic that is monitored and analyzed by the network monitoring devices 202 may enter the network monitoring devices 202 through interfaces 204A-204N (or interfaces 208A-208N for network monitoring devices 206A-206N). After monitoring and analysis by the network monitoring devices, the network traffic may exit the devices through the interfaces if the interfaces are bidirectional, or through other interfaces (not shown) if the interfaces are unidirectional. Each of the devices may have a large number of high-capacity interfaces, such as 32 10-Gigabit network interfaces.

The network monitoring devices 202A-202N and 206A-206N are connected to a forensic network device 210. The forensic network device 210 processes information from opposite sides of the network address translator 106 (i.e., from the network monitoring devices 202A-202N and from the network monitoring devices 206A-206N) to correlate traffic flows on opposite sides of the network address translator. As previously indicated, this is a challenge because the IP addresses and port designations are different on opposite sides of the network address translator 106.

In one embodiment, the forensic network device 210 is connected to a management platform 212. The management platform 212 may be used to perform additional traffic analytics and provide visualizations of network activity.

U.S. Pat. No. 9,407,518 (the '518 patent), which is owned by the current applicant, discloses a network monitoring device that may be configured in accordance with embodiments of the invention. The contents of the '518 patent are incorporated herein by reference.

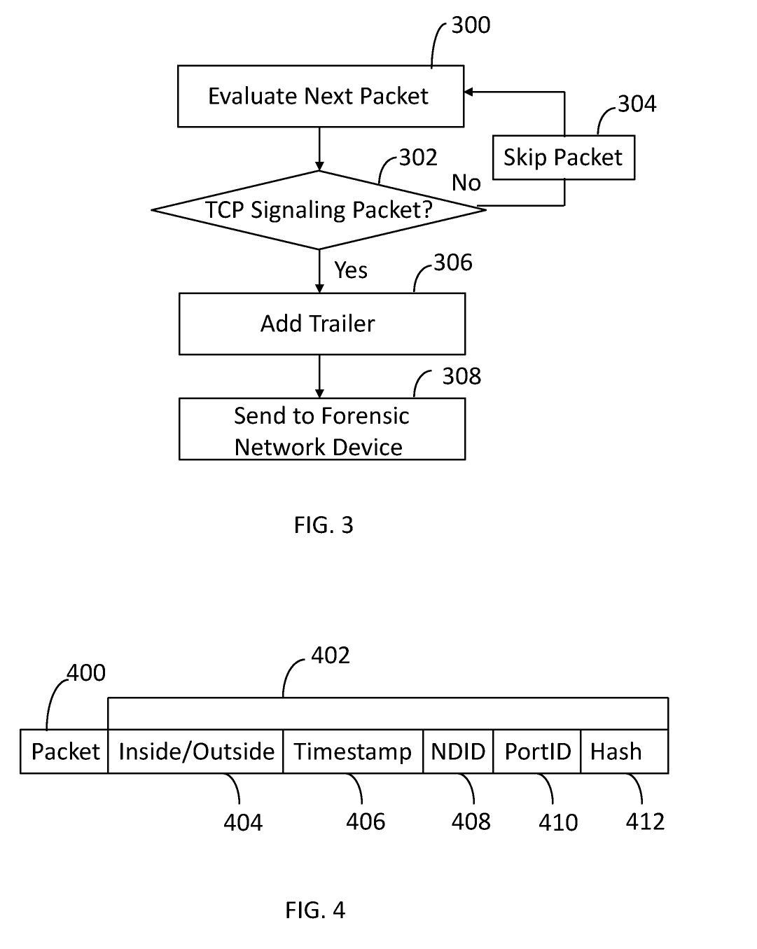

The device of the '518 patent or a device with a similar configuration may be programmed to perform the operations of FIG. 3. A packet is evaluated 300. It is determined whether the packet is a TCP signaling packet (i.e., SYN, SYN-ACK, FIN, FIN-ACK or RST). Characterization of a TCP signaling packet may be limited to egress side communications of SYN-ACK and FIN-ACK.

If the packet is not a TCP signaling packet (302—No), the packet is skipped 304. Control then returns to block 300 for evaluation of the next packet. That is, for the purposes of correlating network traffic flows on opposite sides of a network address translator, only TCP signaling packets are processed. This approach reduces the amount of data that needs to be forwarded and analyzed.

If the packet is a TCP signaling packet (302—Yes), a trailer is added to the packet 306. The packet and the trailer are then sent to the forensic network device 308. FIG. 4 illustrates a packet 400 and an added trailer 402. The trailer has a field 404 to specify which side of the network address translator the packet is from (e.g., inside or outside). The trailer also has a timestamp 406, preferably with nanosecond accuracy. The trailer also has a network device identification 408 and a port identification 410. In one embodiment, a hash 412 is included. The hash is a hash function of the packet contents (excluding the source and destination addresses). The hash may be used to identify identical packets on either side of the network address translator.

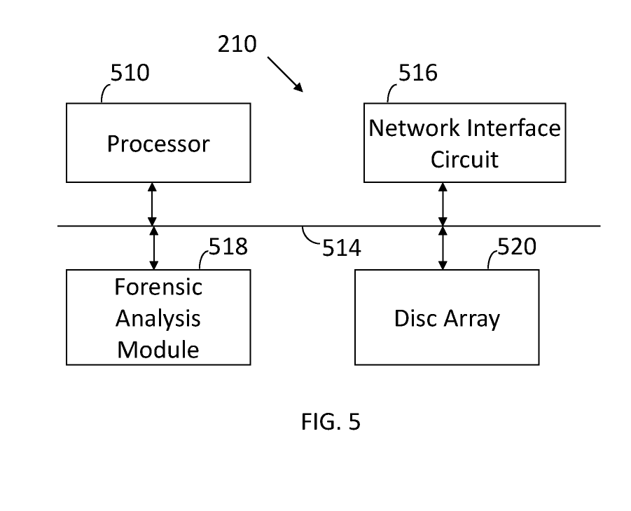

FIG. 5 illustrates an embodiment of the forensic network device 210. The device 210 includes a processor 510 connected to a network interface circuit 516 via a bus 514. The network interface circuit 516 provides connectivity to a network hosting the devices of FIG. 2. A disc array 520 is also connected to the bus 514. Random access memory stores a forensic analysis module 518 with instructions executed by processor 510. The disc array 520 stores packets at line rate. The forensic analysis module 518 includes instructions executed by the processor to perform port forwarding, aggregation, replication, balancing and filtering. The forensic analysis module 518 also supports correlation of network traffic flows on opposite sides of a network address translator.

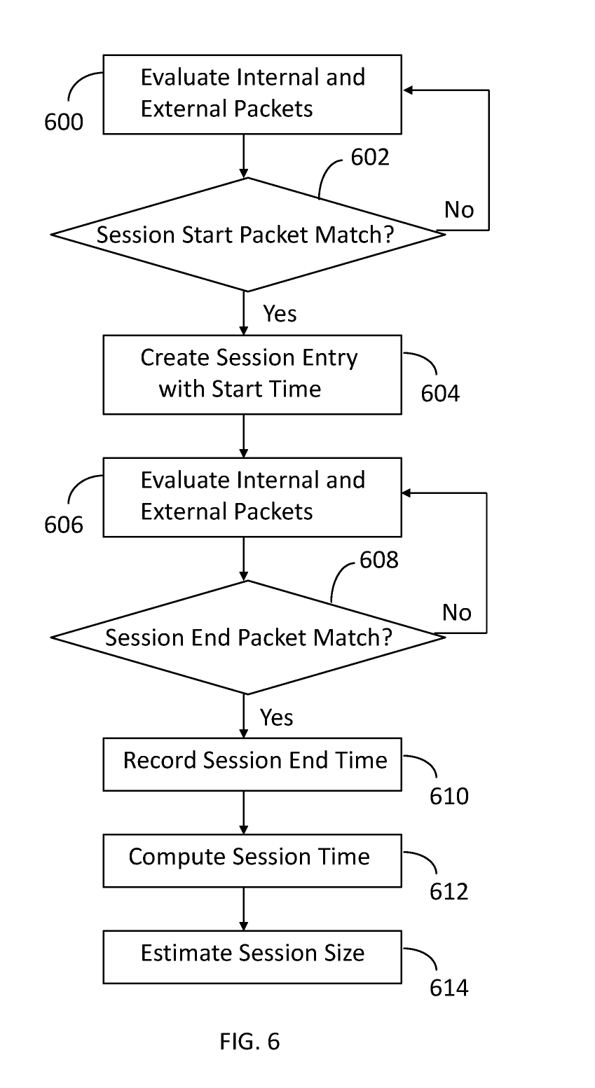

FIG. 6 illustrates processing operations associated with an embodiment of the forensic analysis module 518. Packets from network monitoring devices 202A-202N and 206A-206N are evaluated 600. Recall from the discussion in connection with FIG. 3, these are TCP signaling packets with trailers of the type shown in FIG. 4. If a session start packet is identified (602—Yes) a session entry is created with the start time 604. The session start may be identified by two SYN signals and/or two SYN-ACK signals on either side of the network address translator.

The forensic analysis module 518 may maintain a database of such session entries. The start time is collected from the timestamp field 406 of the trailer 402. If a session start packet is not identified (602—No), control returns to block 600.

After a session entry is created, internal and external packets are evaluated 606 to track a session on either side of the network address translator. A correlation between sessions is identified by identifying a packet from the internal side of the network address translator and the external side of the network address translator that meet a correlation rule, such as “same destination different source” on the egress side and “different destination same source” on the ingress side. The two packets should also have a time stamp that is very close, e.g., within a millisecond threshold. The two packets should also have the same hash, which indicates identical packets, except for the source and IP destinations, which are excluded from the hash. One or more of these correlation rules may be used in accordance with embodiments of the invention.

Packets are processed to identify a session end packet (e.g., a TCP signal of FIN, FIN-ACK or RST). When a session end packet is identified (608—Yes), the session end time is recorded 610. The session time is then computed 612 by taking the difference between the session start time and the session end time. A session size is also estimated 614. The session size may be calculated by writing the TCP sequence numbers and subtracting the end sequence number from the initial sequence number. If the connection is not bigger than 2 GB, then the session size estimate is accurate. If the session size is greater than 2 GB, a heuristic based upon time is used to estimate the session size.

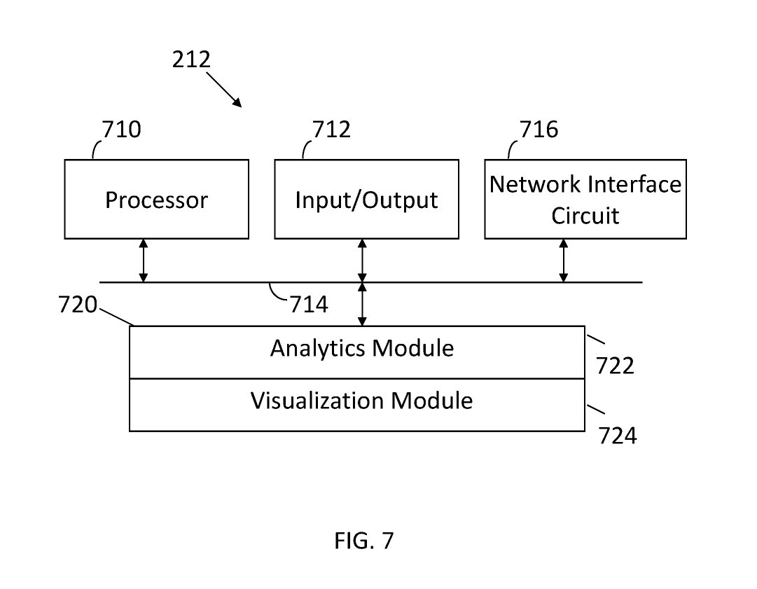

FIG. 7 illustrates a management platform 212 that may be used in accordance with an embodiment of the invention. The management platform 212 may include a processor 710 connected to input/output devices 712 via a bus 714. A network interface circuit 716 is also connected to the bus 714 to provide connectivity to the network hosting the devices of FIG. 2. A memory 720 is also connected to the bus 714. The memory 720 stores instructions executed by the processor 710. In one embodiment, the memory 720 stores an analytics module 722 with instructions executed by the processor 710 to evaluate session information. The session information provides insights on the health of the network. For example, the session information can tell a network operator how many open sessions exist between clients and servers. The session information may also specify how big sessions are and their durations. The analyzed information may also determine the delay across the network address translator.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising;
a processor; and
a memory connected to the processor, the memory storing instructions executed by the processor to:
evaluate internal packets from a first side of a network address translator with a first internet protocol address and a first port designation,
evaluate external packets from a second side of a network address translator with a second internet protocol address and a second port designation, wherein the first internet protocol address and the first port designation are different than the second internet protocol address and the second port designation,
identify within the internal packets and the external packets a session start packet match,
create a session entry with a session start time in response to the session start packet match,
identify within the internal packets and the external packets a session end match, and
record a session end time in response to the session end match.

2. The machine of claim 1 further comprising instructions executed by the processor to compute a session time based upon the session start time and the session end time.

3. The machine of claim 1 further comprising instructions executed by the processor to compute a session size.

4. The machine of claim 3 further comprising instructions executed by the processor to compute the session size based upon the difference between a transmission control protocol end sequence number and a transmission control protocol initial sequence number.

5. The machine of claim 3 further comprising instructions executed by the processor to compute the session size based upon a session time.

6. The machine of claim 1 wherein the instructions executed by the processor include instructions to identify the session start packet match based upon a hash match between an internal packet and an external packet.

7. The machine of claim 1 wherein the instructions executed by the processor include instructions to identify the session start packet match based upon an internal packet time stamp being within a time threshold of an external packet time stamp.

8. The machine of claim 1 wherein the instructions executed by the processor includes instructions to identify the session start packet match based upon same destination address and different source address on egress to the network address translator and different destination address and same source address on ingress from the network address translator.

9. A machine, comprising:
a processor, and
a memory connected to the processor, the memory storing instructions executed by the processor to:
classify packets as transmission control protocol signaling packets or transmission control protocol non-signaling packets,
omit from further processing the transmission control protocol non-signaling packets,
append to the transmission control protocol signaling packets trailers, and
forward the transmission control protocol signaling packets and the trailers to a network connected device for further evaluation.

10. The machine of claim 9 wherein each trailer of the trailers includes a field indicating whether the packet is on the first side of a network address translator or a second side of a network address translator.

11. The machine of claim 9 wherein each trailer of the trailers includes a timestamp.

12. The machine of claim 9 wherein each trailer of the trailers includes a network device identification.

13. The machine of claim 9 wherein each trailer of the trailers includes a port identification.

14. The machine of claim 9 wherein each trailer of the trailers includes a hash of packet contents that omits a source internet protocol address and a destination internet protocol address.
